(19) United States
(12) Patent Application Publication
(10) Pub. No.: US 2015/0089002 A1
(43) Pub. Date: Mar. 26, 2015

(54) ELECTRONIC APPARATUS

(71) Applicant: Kabushiki Kaisha Toshiba, Tokyo (JP)

(72) Inventor: Koji Shima, Sagamihara Kanagawa (JP)

(21) Appl. No.: 14/482,862

(22) Filed: Sep. 10, 2014

Related U.S. Application Data
(60) Provisional application No. 61/883,119, filed on Sep. 26, 2013.

(51) Int. Cl. G11B 20/10; H04L 12/58; G06F 3/16; G10L 15/22

(52) U.S. Cl. CPC G11B 20/10527; G10L 15/22; H04L 51/08; G06F 3/16; G11B 2020/10546; G10L 2015/223
USPC 709/206; 704/201

(57) ABSTRACT

According to one embodiment, an electronic apparatus includes: a microphone; a storage unit which stores at least one of record start instruction keyword; a voice recognition section which recognizes a voice content that is input through the microphone; and a record start execution section which, in a case where the voice content recognized by the voice recognition section is coincident with the record start instruction keyword, executes a record start.

### CROSS-REFERENCE TO RELATED APPLICATION(S)

This application claims priority from U.S. Provisional Patent Application No. 61/883,119 filed on Sep. 26, 2013, the entire contents of which are incorporated herein by reference.

### FIELD

Embodiments described herein relate generally to an electronic apparatus.

### BACKGROUND

An electronic apparatus having a function of recording sound is provided. As to an electronic apparatus, improvement in the convenience of the user is requested.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of an electronic apparatus of an embodiment.

FIG. 2 is a schematic block diagram showing the main functional configuration of the electronic apparatus shown in FIG. 1.

FIG. 3 is a flowchart showing a control procedure of record start in the electronic apparatus shown in FIG. 1.

FIG. 4 shows a confirmation screen of the record start in the electronic apparatus shown in FIG. 1.

FIG. 5 is a flowchart showing a control procedure of record stop in the electronic apparatus shown in FIG. 1.

FIG. 6 shows a confirmation screen of the record stop in the electronic apparatus shown in FIG. 1.

FIG. 7 is a flowchart showing a control procedure of E-mail transmission in the electronic apparatus shown in FIG. 1.

FIG. 8 is a flowchart showing another control procedure of the E-mail transmission in the electronic apparatus shown in FIG. 1.

FIGS. 9A and 9B show confirmation screens of the E-mail transmission in the electronic apparatus shown in FIG. 1.

### DETAILED DESCRIPTION

Various embodiments will be described hereinafter with reference to the accompanying drawings.

In general, according to one embodiment, in an electronic apparatus, a microphone, a storage unit which stores at least one of record start instruction keyword, a voice recognition section which recognizes a voice content that is input through the microphone, and a record start execution section which executes a record start in the case where the voice content recognized by the voice recognition section is coincident with the record start instruction keyword.

Hereinafter, an embodiment will be described with reference to the drawings.

In the specification, several components are denoted by plural expression examples. These expression examples are only exemplifications, and do not deny that the components are indicated by other expressions. Also components which are not denoted by plural expression examples may be indicated by other expressions.

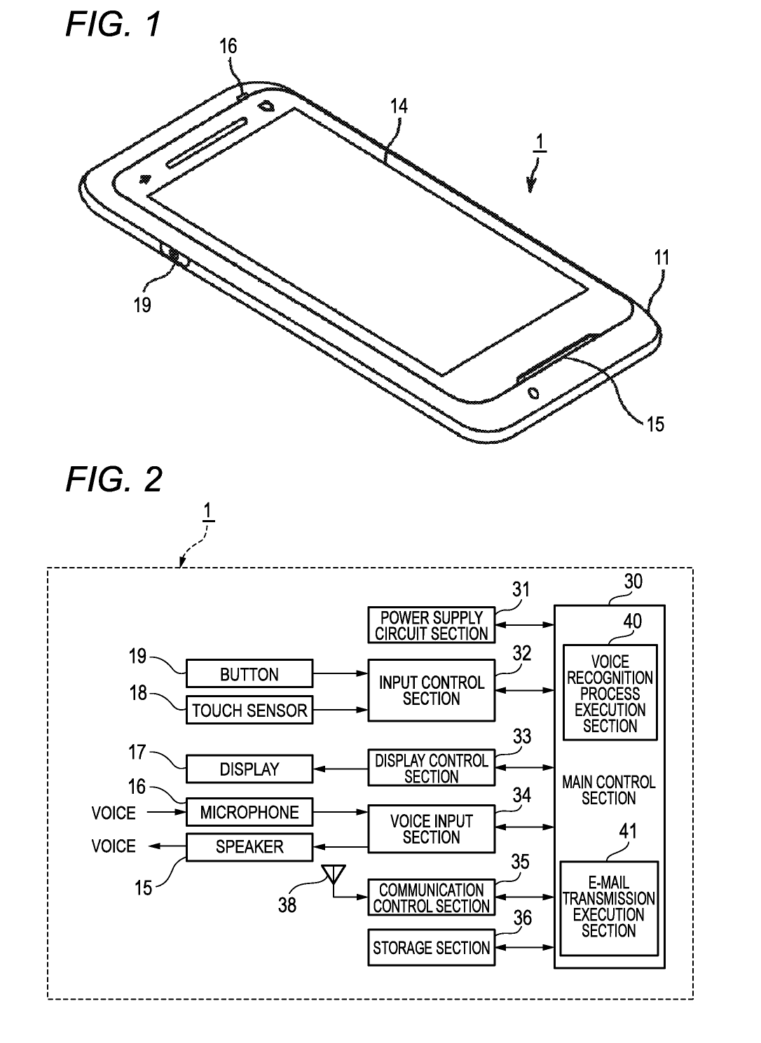

FIGS. 1 to 9B show an electronic apparatus 1 of an embodiment. For example, the electronic apparatus 1 is a tablet type computer (i.e., tablet PC). An electronic apparatus to which the embodiment can be applied is not limited to the example. The embodiment can be widely applied to various electronic apparatuses such as a notebook portable computer (i.e., note PC), an All-in-One Personal Computer (i.e., AIO), a portable telephone (including a smart phone), a portable Music Player, a voice recorder, a game machine, a clock, and a television receiver.

FIG. 1 is an external perspective view showing a tablet PC of the embodiment.

The electronic apparatus 1 includes a rectangular plate-like case 11. A touch panel 14 is configured on one surface of the case 11.

The touch panel 14 has functions of both display and input sections. The touch panel 14 is configured by a display (a display 17 in FIG. 2), plural elements which are arranged on the upper surface, and which are used for detecting a contact operation, and a transparent operation surface (a touch sensor 18 in FIG. 2) which is stacked thereon.

The display 17 includes an area where a display screen configured by characters, an image, and the like is to be displayed. For example, the display 17 is configured by an LCD (Liquid Crystal Display), an organic EL (ElectroLuminescence) display, an inorganic EL display, or the like.

The touch sensor 18 detects an operation of a contact object which is in contact with the operation surface, thereby receiving instructions.

A button 19 is to be pressed by the user, thereby receiving instructions.

In the case 11, a speaker 15 for outputting sound, and a microphone 16 for inputting sound are placed.

FIG. 2 is a schematic block diagram showing the main functional configuration of the electronic apparatus 1 of the embodiment. The electronic apparatus 1 is configured by connecting a main control section 30, a power supply circuit section 31, an input control section 32, a display control section 33, a voice input section 34, a communication control section 35, and a storage section 36 in a manner where they are mutually communicable with one another through a bus.

The main control section 30 includes a CPU (Central Processing Unit). The main control section 30 operates based on various programs stored in the storage section 36 to generally control the electronic apparatus 1.

The power supply circuit section 31 includes a power supply source (not shown). The power supply circuit section 31 switches over the ON/OFF states of the power supply of the electronic apparatus 1 based on an operation of turning ON the power supply. In the case where the power supply is in the ON state, the power supply circuit section 31 supplies electric power from the power supply source to various sections to enable the electronic apparatus 1 to operate.

The input control section 32 includes an input interface for the touch sensor 18 and the button 19. The input control section 32 receives a detection signal from the touch sensor 18 at predetermined time intervals, as information indicative of the coordinates of the input position, produces a signal indicating the input, and transmits the signal to the main control section 30. The input control section 32 further receives a signal indicative of pressing of the button 19, produces a signal indicating the input, and transmits the signal to the main control section 30.

The display control section 33 includes a display interface for the display 17. Based on the control of the main control section 30, the display control section 33 controls the display 17 to display an image corresponding to document data and an image signal.

Based on the control of the main control section 30, the voice input section 34 produces an analog audio signal from sound collected by the microphone 16, and converts the analog audio signal to a digital audio signal. When acquiring a digital audio signal, the voice input section 34 converts the digital audio signal to an analog audio signal, and outputs the signal as sound from the speaker 15 based on the control of the main control section 30.

Based on the control of the main control section 30, the communication control section 35 performs a spectrum reverse diffusion process on a reception signal which is received from a base station through an antenna 38, to reconstruct data. In accordance with instructions from the main control section 30, the data are transmitted to the voice input section 34 to be output from the speaker 15, transmitted to the display control section 33 to be displayed on the display 17, or stored in the storage section 36. When the communication control section 35 further acquires audio data collected by the microphone 16, data which are input through the touch sensor 18, or data stored in the storage section 36 based on the control of the main control section 30, the section performs a spectrum reverse diffusion process on the data, and transmits the data to a base station through the antenna 38.

The storage section 36 is configured by: a ROM (Read Only Memory), hard disk drive, non-volatile memory, or data base which stores processing programs for processes to be performed by the main control section 30, data required in the processes, and the like; a RAM (Random Access Memory) which temporarily stores data to be used when the main control section 30 performs the processes; etc. Particularly, the storage section 36 stores processing programs for various processes to be performed by the main control section 30 in the embodiment.

The storage section 36 stores plural predetermined voice recognition processes corresponding to a digital signal which is output from the voice input section 34. For example, the plural voice recognition processes include at least a process in which voice is received as a command, and a predetermined application is operated by the command. In a word-processing software application, with respect to a digital signal for voice of “Save” which is uttered by the user toward the microphone 16, for example, a process of saving a document in preparation is a voice recognition process.

The storage section 36 further stores E-mail addresses which are destinations of E-mail transmissions. Particularly, the storage section stores a specific E-mail address which is used in an E-mail transmission process in the embodiment. The specific E-mail address may be arbitrarily designated (registered) by the user from plural E-mail addresses stored in the storage section 36.

A voice recognition process execution section 40 performs a recognition process on the voice content based on the digital signal which is output from the voice input section 34, and then detects whether matching with the voice recognition process (voice command) stored in the storage section 36 is achieved or not. If matching is achieved, the voice recognition process (voice command) is executed.

An E-mail transmission execution section 41 executes E-mail transmission to an E-mail address stored in the storage section 36 in accordance with the voice recognition process (voice command).

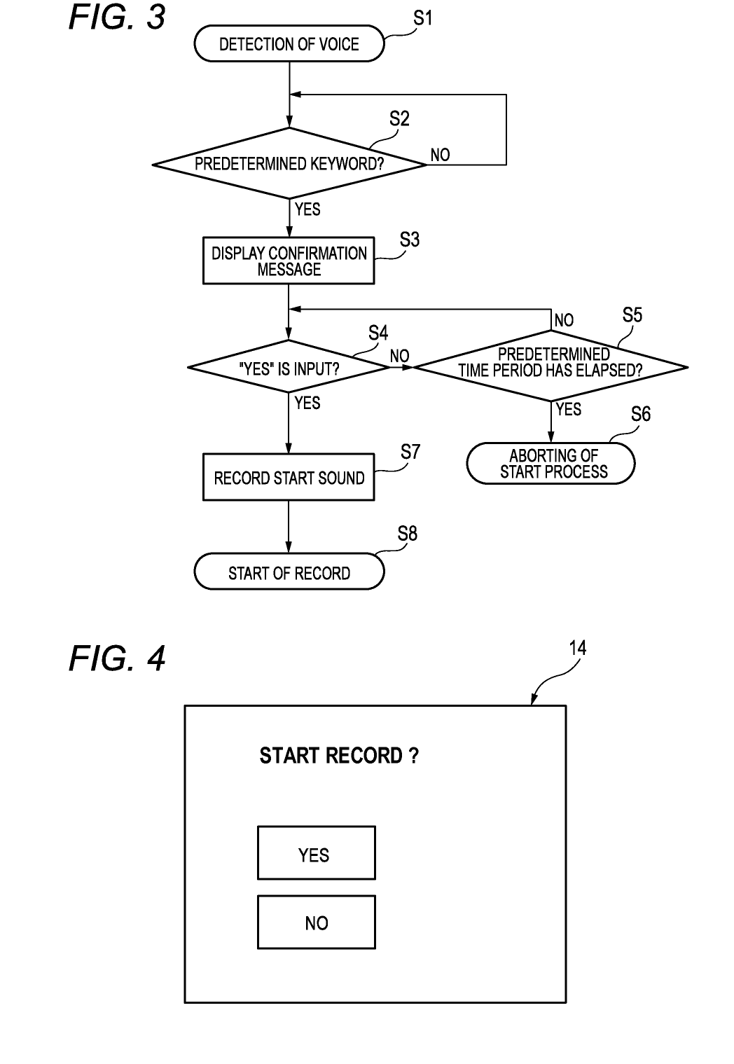

Next, the control operation of record start in the electronic apparatus 1 of the embodiment will be described with reference to the flowchart of FIG. 3.

In the following description of the operation, it is assumed that the power supply of the apparatus body is turned ON before the operation in the following step.

In step S1, first, the voice input section 34 detects that voice is input through the microphone 16. In step S2, then, the voice recognition process execution section 40 detects whether the digital signal output from the voice input section 34 matches with one of the plural voice commands (for example, “Record”, “Record start”, and the like) stored in the storage section 36.

If there is matching (Yes in step S2), a confirmation message as to whether record is to be started or not is displayed (step S3). FIG. 4 shows an example of a message displayed for confirming whether record is to be started or not. FIG. 4 shows a screen of a confirmation message in the case where the voice command is “Record”.

In step S4, next, the voice recognition process execution section 40 detects whether the digital signal output from the voice input section 34 is “Yes” or not. If “Yes” (Yes in step S4), a record start sound is output from the speaker 15, and the voice command of (Record) is executed (step S8).

If the voice input section 34 does not detect in step S4 that an input of voice sounds through the microphone 16 exists, or if the voice recognition process execution section 40 detects that the digital signal output from the voice input section 34 is not “Yes” (No in step S4), the control waits for an elapse of a predetermined time period (for example, 3 seconds) (step S5), and then the process of the voice command is cancelled to abort the record start process (step S6).

According to the embodiment, the user can cause the apparatus to start record by uttering voice sounds without picking up and operating the apparatus. Therefore, the convenience of the user can be improved.

In the embodiment, a part or all of the processes of steps S3 to S7 may be omitted. In the case where all of the processes are omitted, if the voice recognition process execution section 40 detects in step S2 that the digital signal output from the voice input section 34 matches with one of the plural voice commands stored in the storage section 36, the voice command (Record) is executed (step S8). At this time, the record content is stored in the storage section 36 in a usual file format (for example, the MPG format or the like).

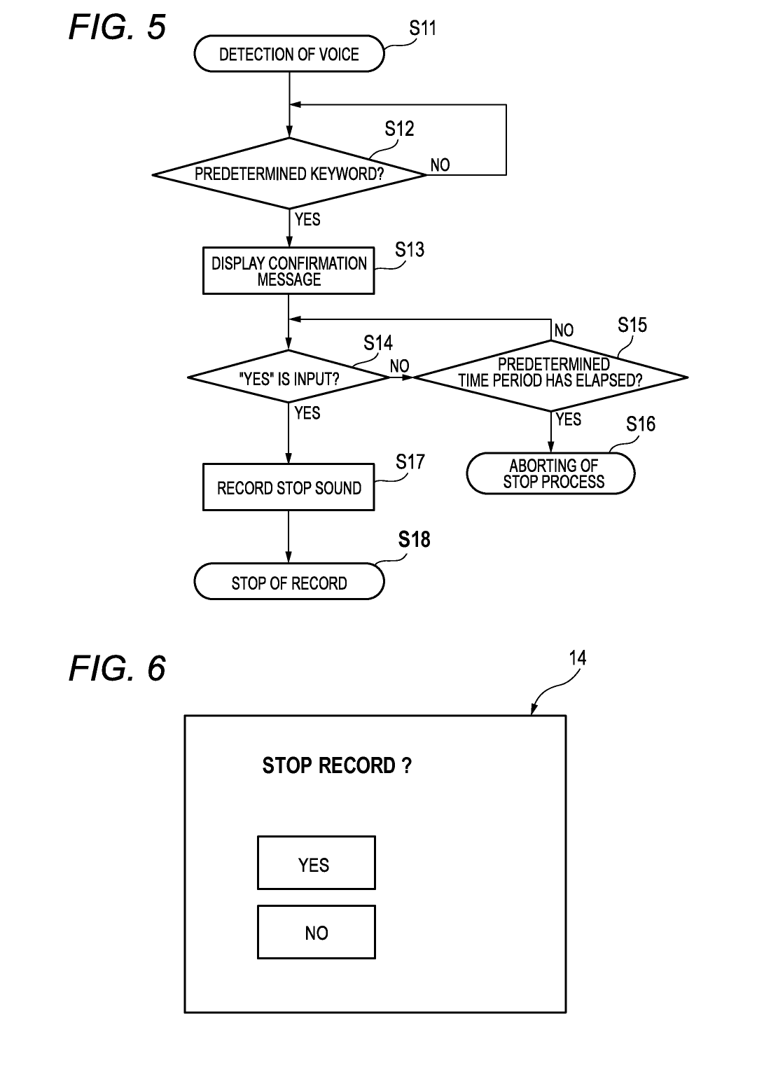

Next, the control operation of record stop in the electronic apparatus 1 of the embodiment will be described with reference to the flowchart of FIG. 5.

In the following description of the operation, it is assumed that record is started before the operation in the following step (step S8 in FIG. 3).

In step S11, first, the voice input section 34 detects that voice is input through the microphone 16. In step S12, then, the voice recognition process execution section 40 detects whether the digital signal output from the voice input section 34 matches with one of the plural voice commands (for example, “Stop”, “Record stop”, and the like) stored in the storage section 36.

If there is matching (Yes in step S12), a confirmation message as to whether record is to be stopped or not is displayed (step S13). FIG. 6 shows an example of a message displayed for confirming whether record is to be stopped or not. FIG. 6 shows a screen of a confirmation message in the case where the voice command is “Record stop”.

In step S14, next, the voice recognition process execution section 40 detects whether the digital signal output from the voice input section 34 is “Yes” or not. If “Yes” (Yes in step S14), a record stop sound is output from the speaker 15, and the voice command of “Record stop” is executed (step S18).

If the voice input section 34 does not detect in step S14 that an input of voice sounds through the microphone 16 exists, or if the voice recognition process execution section 40 detects that the digital signal output from the voice input section 34 is not “Yes” (No in step S14), the control waits for an elapse of a predetermined time period (for example, 3 seconds) (step S15), and then the process of the voice command is cancelled to abort the record stop process (step S16).

According to the embodiment, the user can cause the apparatus to stop record by uttering voice sounds without picking up and operating the apparatus. Therefore, the convenience of the user can be improved.

In the embodiment, a part or all of the processes of steps S13 to S17 may be omitted. In the case where all of the processes are omitted, if the voice recognition process execution section 40 detects in step S12 that the digital signal output from the voice input section 34 matches with one of the plural voice commands stored in the storage section 36, the voice command (Record stop) is executed (step S18). At this time, the process of storing into the storage section 36 is ended.

In the embodiment, when the user utters voice sounds, the record stop process is performed. The invention is not limited to this. When a predetermined time period has elapsed after record start (step S8 in FIG. 3), for example, record may be automatically stopped.

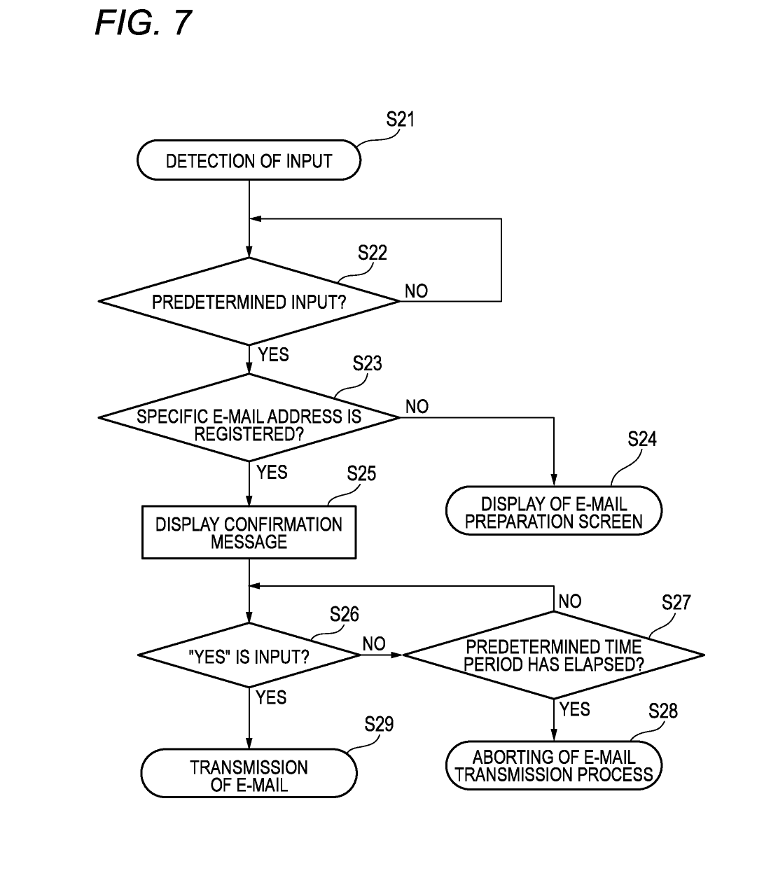

Next, the control operation of E-mail transmission in the electronic apparatus 1 of the embodiment will be described with reference to the flowchart of FIG. 7.

In the following description of the operation, it is assumed that, before the operation in the following step, record is started (step S8 in FIG. 3), the record is stopped (step S18 in FIG. 5), and the record content is stored in the storage section 36.

In step S21, first, the input control section 32 detects that the touch sensor 18 or the button 19 is input. In step S22, then, the E-mail transmission execution section 41 detects whether the digital signal output from the voice input section 32 matches with one of plural input commands (for example, “Transmission”, “E-mail transmission”, “Transmission to Mr. A”, and the like) stored in the storage section 36. For example, an input corresponding to plural input commands is pressing of the button 19 in the case where the button 19 is a dedicated button. Alternatively, the input is the case where the user touches a predetermined place of the touch sensor 18. In order to prevent an erroneous operation from occurring, an input may be received only when the button 19 is pressed two consecutive times for a short time period.

If there is matching (Yes in step S22), the E-mail transmission execution section 41 detects in step S23 whether a specific E-mail address is registered in the storage section 36 or not.

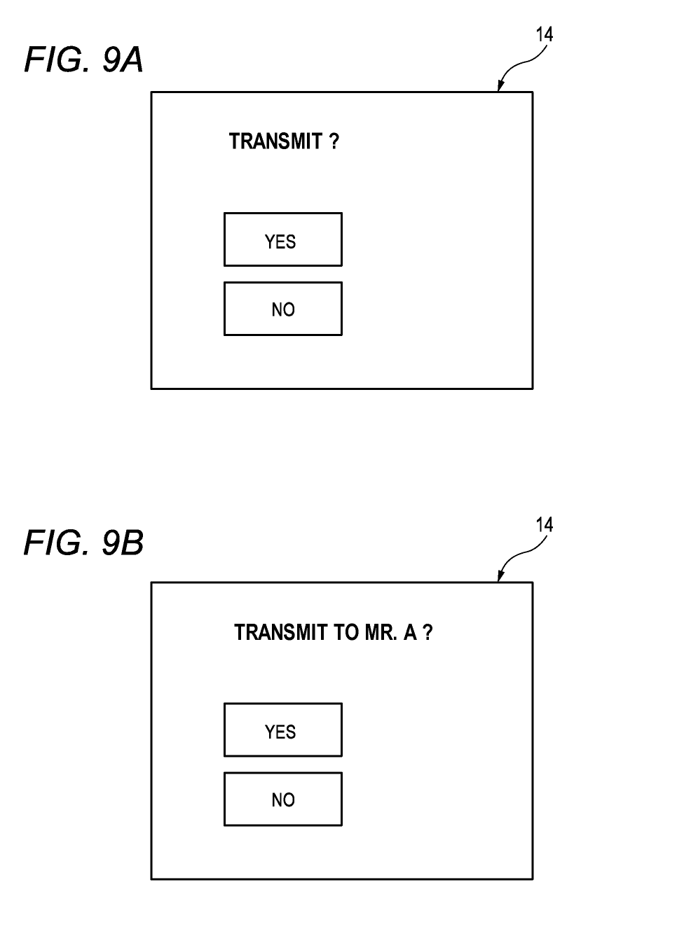

If a specific E-mail address is registered (Yes in step S23), a confirmation message as to whether an E-mail is to be transmitted or not is displayed (step S25). FIGS. 9A and 9B show examples of messages displayed for confirming whether an E-mail is to be transmitted or not. FIG. 9A shows a screen of the confirmation message in the case where a single specific E-mail address is used, and the input command is “E-mail transmission”. FIG. 9B shows a screen of the confirmation message in the case where plural specific E-mail addresses are used, and the input command is “Transmission to Mr. A”.

If it is detected in step S23 that a specific E-mail address is not registered (No in step S23), an E-mail preparation screen for transmitting an E-mail is displayed (step S24). In this case, when the user performs the usual production of an E-mail, the user can transmit the E-mail.

In step S26, next, the voice recognition process execution section 40 detects whether the digital signal output from the voice input section 34 is “Yes” or not. If “Yes” (Yes in step S26), a process of transmitting an E-mail attached with the record content stored in the storage section 36 is executed on the specific E-mail address (step S29).

If the voice input section 34 does not detect in step S26 that an input of voice sounds through the microphone 16 exists, or if the voice recognition process execution section 40 detects that the digital signal output from the voice input section 34 is not “Yes” (No in step S26), the control waits for an elapse of a predetermined time period (for example, 3 seconds) (step S27), and then the process of the voice command is cancelled to abort the E-mail transmission process (step S28).

According to the embodiment, the user can transmit an E-mail attached with the record content to a specific destination by uttering voice sounds without picking up and operating the apparatus. Therefore, the convenience of the user can be improved.

In the embodiment, a part or all of the processes of steps S25 to S28 may be omitted. In the case where all of the processes are omitted, if it is detected in step S23 that a specific E-mail address is registered, the process of transmitting an E-mail attached with the record content stored in the storage section 36 is executed on the specific E-mail address (step S29).

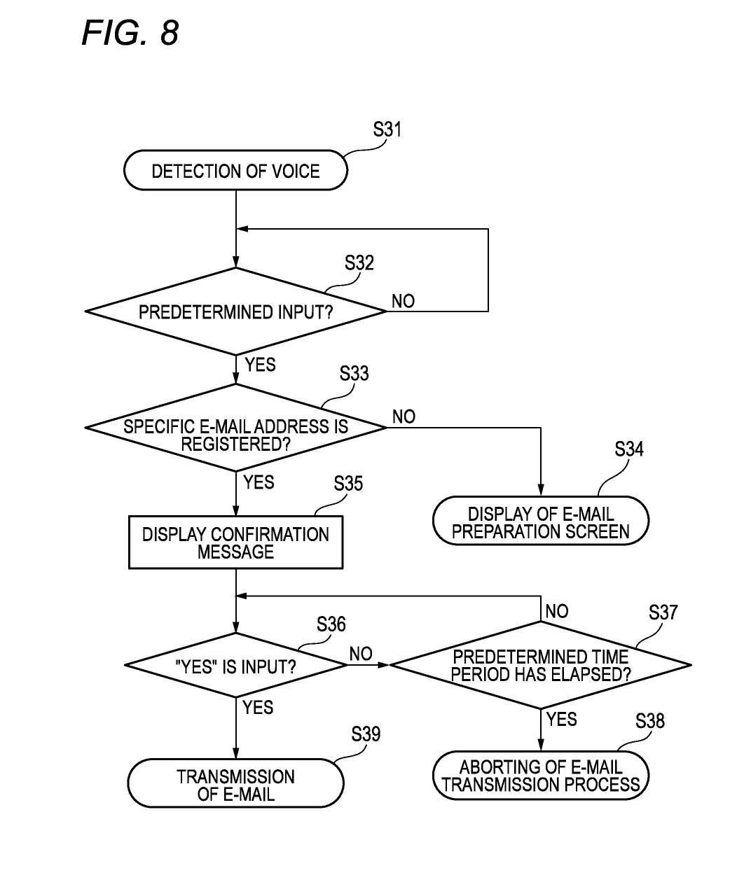

Next, another control operation of the E-mail transmission in the electronic apparatus 1 of the embodiment will be described with reference to the flowchart of FIG. 8.

In the following description of the operation, it is assumed that, before the operation in the following step, record is started (step S8 in FIG. 3), the record is stopped (step S18 in FIG. 5), and the record content is stored in the storage section 36.

In step S31, first, the voice input section 34 detects that voice is input through the microphone 16. In step S32, then, the voice recognition process execution section 40 detects whether the digital signal output from the voice input section 34 matches with one of the plural voice commands (for example, “Transmission”, “E-mail transmission”, “Transmission to Mr. A”, and the like) stored in the storage section 36.

If there is matching (Yes in step S32), the E-mail transmission execution section 41 detects in step S33 whether a specific E-mail address is registered in the storage section 36 or not.

If a specific E-mail address is registered (Yes in step S33), a confirmation message as to whether an E-mail is to be transmitted or not is displayed (step S35). FIGS. 9A and 9B show the examples of the messages displayed for confirming whether an E-mail is to be transmitted or not. FIG. 9A shows the screen of the confirmation message in the case where a single specific E-mail address is used, and the voice command is “E-mail transmission”. FIG. 9B shows the screen of the confirmation message in the case where plural specific E-mail addresses are used, and the voice command is “Transmission to Mr. A”.

If it is detected in step S33 that a specific E-mail address is not registered (No in step S33), an E-mail preparation screen for transmitting an E-mail is displayed (step S34). In this case, when the user performs the usual production of an E-mail, the user can transmit the E-mail.

In step S36, next, the voice recognition process execution section 40 detects whether the digital signal output from the voice input section 34 is “Yes” or not. If “Yes” (Yes in step S36), a process of transmitting an E-mail attached with the record content stored in the storage section 36 is executed on the specific E-mail address (step S39).

If the voice input section 34 does not detect in step S36 that an input of voice sounds through the microphone 16 exists, or if the voice recognition process execution section 40 detects that the digital signal output from the voice input section 34 is not “Yes” (No in step S36), the control waits for an elapse of predetermined time period (for example, 3 seconds) (step S37), and then the process of the voice command is cancelled to abort the E-mail transmission process (step S38).

According to the embodiment, the user can transmit an E-mail attached with the record content to a specific destination by uttering voice sounds without picking up and operating the apparatus. Therefore, the convenience of the user can be improved.

In the embodiment, a part or all of the processes of steps S35 to S38 may be omitted. In the case where all of the processes are omitted, if it is detected in step S33 that a specific E-mail address is registered, the process of transmitting an E-mail attached with the record content stored in the storage section 36 is executed on the specific E-mail address (step S39).

In the case where an E-mail is to be transmitted, the record content may be automatically translated to another language (for example, to/from English and the like), and converted to text document data, and the text document data may be attached to the E-mail together with the record content.

The electronic apparatus of the embodiment has the communication control section 35 which transmits data to a base station connected to the Internet network. However, there is an electronic apparatus having no communication control section which transmits data to a base station, such as an alarm clock.

In this case, the record content and specific E-mail address which are stored in the storage section 36 are transmitted to another electronic apparatus having a communication control section which transmits data to a base station. Then, the other electronic apparatus executes the process of transmitting an E-mail attached with the record content, on the specific E-mail address.

As a method of communicating between the electronic apparatus of the embodiment and the other electronic apparatus, for example, there is a short-distance wireless communication such as Wi-Fi (registered trademark) or Bluetooth (registered trademark).

In steps S4, S14, S26, and S36 in the embodiment, the detection of “Yes” is performed by a voice recognition process. The detection method is not limited to this. The detection of “Yes” may be performed by a process in which the input control section 32 detects that the touch sensor 18 or the button 19 is input.

The technique described in the embodiment may be distributed while being stored in the form of a program which is executable by a computer, in a storage medium such as a magnet disk (a flexible disk, a hard disk, or the like), an optical disk (a CD-ROM, a DVD, or the like), or a magnetooptical disk (MO), or a semiconductor memory, and then distributed.

As the storage medium, any storage medium may be used as far as it can store a program and be read by a computer, and have any storage format.

A part of the processes for realizing the embodiment may be executed by an OS (Operating System), MW (MiddleWare) such as a database management software or network software, and the like which run in the computer based on instructions from a program that is installed from a storage medium in the computer.

The storage medium in the invention is not limited to a medium which is independent from a computer, and includes also a storage medium into which a program transmitted through a LAN, the Internet, or the like is downloaded, and which stores or temporarily stores the program.

The number of the storage medium is not limited to one. The storage medium of the invention includes also the case where the process in the embodiment is executed from plural storage media, and such media may have any configuration.

The functions of the modules which have been described in the embodiment may be realized by a software application which is executed by a processor, by a processing circuit implemented by hardware, by hardware, or by a combination of a software application, hardware, and a software module.

While certain embodiments have been described, these embodiments have been presented by way of example only, and are not intended to limit the scope of the inventions. Indeed, the novel embodiments described herein may be embodied in a variety of other forms, furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An electronic apparatus comprising:
a microphone;
a storage unit which stores at least one of record start instruction keyword;
a voice recognition section which recognizes a voice content that is input through the microphone; and
a record start execution section which, in a case where the voice content recognized by the voice recognition section is coincident with the record start instruction keyword, executes a record start.

2. The electronic apparatus of claim 1, further comprising:
a display section; and
a display control section which, before executing the record start, displays a confirmation message as to whether record is to be started or not, on the display section.

3. The electronic apparatus of claim 2,
wherein, in a case where the voice content recognized by the voice recognition section indicates allowance of the record start, the record start execution section executes the record start.

4. The electronic apparatus of claim 2, further comprising:
an input section,
wherein, in a case where an input of the input section indicates allowance of the record start, the record start execution section executes the record start.

5. The electronic apparatus of claim 1,
wherein the storage unit stores at least one of record stop instruction keyword, and
wherein the electronic apparatus further comprises a record stop execution section which, in a case where, after executing the record start, a voice content recognized by the voice recognition section is coincident with the record stop instruction keyword, executes the record stop.

6. The electronic apparatus of claim 5,
wherein, after executing the record stop, the storage unit stores a record content by converting it to have a predetermined file format.

7. The electronic apparatus of claim 5, further comprising:
a display section; and
a display control section which, before executing the record stop, displays a confirmation message as to whether record is to be stopped or not, on the display section.

8. The electronic apparatus of claim 7,
wherein, in a case where the voice content recognized by the voice recognition section indicates allowance of the record stop, the record stop execution section executes the record stop.

9. The electronic apparatus of claim 7, further comprising:
an input section,
wherein, in a case where an input of the input section indicates allowance of the record stop, the record stop execution section executes the record stop.

10. The electronic apparatus of claim 1, further comprising:
a record stop execution section which, in a case where the record start is executed, executes the record stop when a predetermined time period has elapsed after the record start.

11. The electronic apparatus of claim 6,
wherein the storage unit stores at least one of E-mail address,
wherein the storage unit stores at least one of E-mail transmission instruction keyword, and
wherein the electronic apparatus further comprises an E-mail transmission execution section which, in a case where, after executing the record stop, a voice content recognized by the voice recognition section is coincident with the E-mail transmission instruction keyword, transmits an E-mail attached with the file stored in the storage unit, to an E-mail address stored in the storage unit.

12. The electronic apparatus of claim 11, further comprising:
a display section; and
a display control section which, before executing the E-mail transmission, displays a confirmation message as to whether the E-mail transmission is to be stopped or not, on the display section.

13. The electronic apparatus of claim 12,
wherein, in a case where the voice content recognized by the voice recognition section indicates stop of the E-mail transmission, the E-mail transmission execution section stops the E-mail transmission.

14. The electronic apparatus of claim 12, further comprising:
an input section,
wherein, in a case where an input of the input section indicates stop of the E-mail transmission, the E-mail transmission execution section stops the E-mail transmission.
